(19) United States
(12) Patent Application Publication
(10) Pub. No.: US 2016/0018984 A1
(43) Pub. Date: Jan. 21, 2016

(54) METHOD OF ACTIVATING USER INTERFACE AND ELECTRONIC DEVICE SUPPORTING THE SAME

(71) Applicant: Samsung Electronics Co., Ltd., Suwon-si (KR)

(72) Inventors: Kyuok CHOI, Seoul (KR); Areum KIM, Seoul (KR)

(21) Appl. No.: 14/798,931

(22) Filed: Jul. 14, 2015

(30) Foreign Application Priority Data
Jul. 16, 2014 (KR) 10-2014-0089680

(51) Int. Cl. G06F 3/0488; G06F 3/16; G06F 3/0484

(52) U.S. Cl. CPC G06F 3/04883; G06F 3/0484; G06F 3/165

(57) ABSTRACT

A method of activating a user interface in an electronic device is provided. The method includes detecting a touch input event in a certain area of a locked state screen, determining whether the touch input event is maintained for a predetermined threshold time, and displaying a user interface that provides a pre-set function on the screen based on a result of determination on whether the touch input event is maintained by the controller.

### CROSS-REFERENCE TO RELATED APPLICATION(S)

This application claims the benefit under 35 U.S.C. §119(a) of a Korean patent application filed on Jul. 16, 2014 in the Korean Intellectual Property Office and assigned serial number 10-2014-0089680, the entire disclosure of which is hereby incorporated by reference.

### TECHNICAL FIELD

The present disclosure relates to a method of activating a user interface and an electronic device supporting the same. More particularly, the present disclosure relates to a method of activating a user interface from a locked screen and an electronic device supporting the same.

### BACKGROUND

Recently, with a rapid increase in the use of various electronic devices, an electronic device has become a staple of modern life. Electronic devices have been transformed into an electronic device that can execute multimedia data for playing an image or audio files, as well as a voice call service, and various data transmission services.

In addition, the electronic device may provide various functions such as a geographic location function, a music playing function, a camera function, and the like. A user input may be required in order to control such a function and various input devices may be provided within the electronic device in order to detect such a user input and perform a corresponding function. For example, the electronic device may be equipped with at least one hardware key (e.g., home key, volume key, and the like), and may perform a corresponding function when an input is detected at the key at least one hardware key.

In an electronic device according to the related art, in order to activate a locked screen, a predetermined user interface can be displayed only in response to an input being detected at a hardware key (e.g., home key) associated with the electronic device. Thus, when there is an environmental constraint, for example, when a user is in the dark space and thus it is difficult to visually detect the hardware key, it is inconvenient for the user to activate the electronic device using only the hardware key.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method for activating a user interface that can reduce the above problems, and an electronic device supporting the same.

In accordance with an aspect of the present disclosure, a method of activating a user interface in an electronic device is provided. The method includes detecting a touch input event in a certain area of a locked state screen, determining whether the touch input event is maintained for a predetermined threshold time, and displaying a user interface that provides a pre-set function on the screen based on a result of determination on whether the touch input event is maintained.

In accordance with another aspect of the present disclosure, an electronic device is provided. The electronic device includes a display unit configured to detect a touch input event in a certain area of a locked state screen, and a controller configured to determine whether the touch input event is maintained for a predetermined threshold time, and display a user interface that provides a pre-set function on the screen based on a result of determination on whether the touch input event is maintained.

The electronic device according to an embodiment of the present disclosure may activate a screen by a touch input event within a predetermined effective touch area of the locked state screen. This can increase the usability and the accessibility to the electronic device for a user.

The electronic device according to an embodiment of the present disclosure may detect a touch input event in a certain area within a predetermined effective touch area of the locked state screen and may display an image item in the certain area where the touch input event is detected. This enables a user to perform a function corresponding to the image item conveniently.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following detailed description in conjunction with the accompanying drawings, in which:

FIG. 1 is a block diagram illustrating a schematic configuration of an electronic device according to an embodiment of the present disclosure;

FIG. 2 and FIG. 3 are schematic diagrams illustrating an operation of controlling a display of user interface in an electronic device according to various embodiments of the present disclosure;

FIGS. 4, 5, 6, 7, and 8 are schematic diagrams illustrating an operation of controlling a display of image item in an electronic device according to various embodiments of the present disclosure;

FIGS. 9, 10, and 11 are schematic diagrams illustrating an operation of controlling a display of an image item providing a lock release function in an electronic device according to various embodiments of the present disclosure;

FIG. 12 is a schematic diagram illustrating an operation of displaying a user interface so as to perform an application function in an electronic device according to various embodiments of the present disclosure;

FIG. 13 is a flowchart illustrating a process of activating a user interface in an electronic device according to various embodiments of the present disclosure;

FIG. 14 is a flowchart illustrating a process of activating a user interface in an electronic device according to various embodiments of the present disclosure; and

FIG. 15 is a flowchart illustrating a process of activating a user interface in an electronic device according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An expression “comprising” or “may comprise” used in the present disclosure indicates presence of a corresponding function, operation, or element and does not limit additional at least one function, operation, or element. Further, in the present disclosure, a term “comprise” or “have” indicates presence of a characteristic, numeral, step, operation, element, component, or combination thereof described in a specification and does not exclude presence or addition of at least one other characteristic, numeral, step, operation, element, component, or combination thereof.

In the present disclosure, an expression “or” includes any combination or the entire combination of together listed words. For example, “A or B” may include A, B, or A and B.

An expression of a first and a second in the present disclosure may represent various elements of the present disclosure, but do not limit corresponding elements. For example, the expression does not limit order and/or importance of corresponding elements. The expression may be used for distinguishing one element from another element. For example, both a first user device and a second user device are user devices and represent different user devices. For example, a first constituent element may be referred to as a second constituent element without deviating from the scope of the present disclosure, and similarly, a second constituent element may be referred to as a first constituent element.

When it is described that an element is “coupled” to another element, the element may be “directly coupled” to the other element or “electrically coupled” to the other element through a third element. However, when it is described that an element is “directly coupled” to another element, no element may exist between the element and the other element.

Terms used in the present disclosure are not to limit the present disclosure but to illustrate various embodiments. When using in a description of the present disclosure and the appended claims, a singular form includes a plurality of forms unless it is explicitly differently represented.

Unless differently defined, entire terms including a technical term and a scientific term used here have the same meaning as a meaning that may be generally understood by a person of common skill in the art. It should be analyzed that generally using terms defined in a dictionary have a meaning corresponding to that of a context of related technology and are not analyzed as an ideal or excessively formal meaning unless explicitly defined.

In this disclosure, an electronic device may be a device that involves a communication function. For example, an electronic device may be a smart phone, a tablet personal computer (PC), a mobile phone, a video phone, an e-book reader, a desktop PC, a laptop PC, a netbook computer, a personal digital assistant (PDA), a portable multimedia player (PMP), an MP3 player, a portable medical device, a digital camera, or a wearable device (e.g., an head-mounted device (HMD) such as electronic glasses, electronic clothes, an electronic bracelet, an electronic necklace, an electronic appcessory, or a smart watch).

According to some embodiments, an electronic device may be a smart home appliance that involves a communication function. For example, an electronic device may be a television (TV), a digital versatile disc (DVD) player, audio equipment, a refrigerator, an air conditioner, a vacuum cleaner, an oven, a microwave, a washing machine, an air cleaner, a set-top box, a TV box (e.g., Samsung HOMESYNC, APPLE TV, GOOGLE TV, etc.), a game console, an electronic dictionary, an electronic key, a camcorder, or an electronic picture frame.

According to some embodiments, an electronic device may be a medical device (e.g., magnetic resonance angiography (MRA), magnetic resonance imaging (MRI), computed tomography (CT), ultrasonography, etc.), a navigation device, a global positioning system (GPS) receiver, an event data recorder (EDR), an flight data recorder (FDR), a car infotainment device, electronic equipment for ship (e.g., a marine navigation system, a gyrocompass, etc.), avionics, security equipment, or an industrial or home robot.

According to some embodiments, an electronic device may be furniture or part of a building or construction having a communication function, an electronic board, an electronic signature receiving device, a projector, or various measuring instruments (e.g., a water meter, an electric meter, a gas meter, a wave meter, etc.). An electronic device disclosed herein may be one of the above-mentioned devices or any combination thereof. As well understood by those skilled in the art, the above-mentioned electronic devices are exemplary only and not to be considered as a limitation of this disclosure.

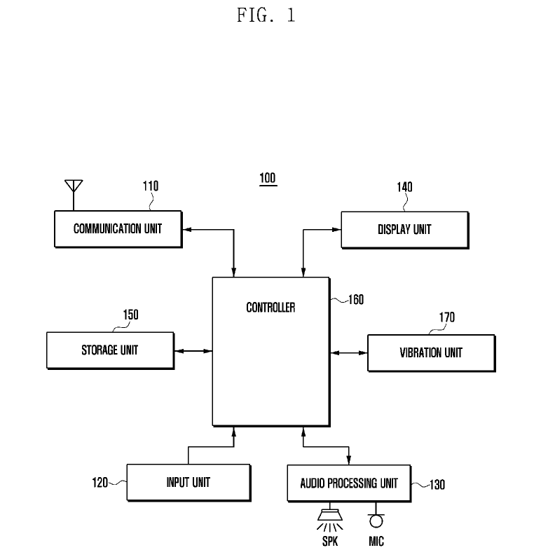

FIG. 1 is a block diagram illustrating a schematic configuration of an electronic device according to an embodiment of the present disclosure.

Referring to FIG. 1, the electronic device 100 may include a communication unit 110, an input unit 120, an audio processing unit 130, a display unit 140, a storage unit 150, a controller 160, and a vibration unit 170.

The communication unit 110 is a communication module configured to transmit and receive communications by the electronic device. In an exemplary embodiment, the communications can include a mobile communication service. The communication unit 110 may establish a communication channel with a mobile communication system. To this end, the communication unit 110 may include a radio frequency transmitter for up-converting and amplifying a frequency of a transmitted signal and a receiver for low-noise amplifying a received signal and down-converting a frequency.

The input unit 120 may include a plurality of input keys and function keys for receiving numeric or character information and setting various functions. The function keys may include a direction key set, a side key, and a shortcut key to perform a specific function. In addition, the input unit 120 may generate a key signal related to a user setting and a function control of the electronic device 100 where the signal is transmitted to the controller 160.

The audio processing unit 130 may include a speaker (SPK) for outputting an audio signal transmitted from the controller 160, and a microphone (MIC) for collecting an audio signal according to the activation of a specific application of the electronic device 100. When the communication unit 110 is activated, the audio processing unit 130 may output an audio signal received through the communication unit 110.

The display unit 140 may display information inputted by a user or information provided to the user, as well as various menus of the electronic device 100. That is, the display unit 140 may provide various screens according to the use of the electronic device 100. For example, a standby screen, a menu screen, a message writing screen, a call screen, and the like may be displayed on the display unit 140. The display unit 140 may be formed of a liquid crystal display (LCD), an organic light emitted diode (OLED) and the like, and may be included in an input means. In addition, the electronic device 100 may provide various menu screens that can be performed based on the display unit 140 as the display unit 140 is supported.

The display unit 140 may be provided in the form of a touch screen by being combined with a touch panel. For example, the touch screen may be formed of an integrated module in which a display panel is combined with the touch panel in a laminated structure. The touch panel may recognize a touch input by the user by at least one of, for example, a capacitive type, a resistive type, an infrared type, or an ultrasonic type. The touch panel may further include a controller (not shown). Meanwhile, the capacitive type may perform proximity recognition as well as direct recognition. The touch panel may further include a tactile layer. In this case, the touch panel may provide a tactile response to the user. In an embodiment, the display unit 140 may detect a touch input event requesting the performance of the function of a portable terminal 100. The display unit 140 may send information corresponding to the detected touch input event to the controller 160.

According to an embodiment of the present disclosure, the display unit 140 may detect the touch input event in a certain area when the screen is in a locked state. In this case, the locked state of screen may be a reception standby state where the electronic device 100 can receive data from an external device, a state where a user interface displayed on the screen does not exist, and a state where a standby screen user interface can be activated by the input unit 120 (e.g., a home key, a hardware key, etc), and the like.

The storage unit 150 may store an application for interaction with various stored files, a key map or a menu map for the operation of the display unit 140, in addition to an application necessary for a function operation according to an embodiment of the present disclosure. Here, the key map and the menu map may have various forms.

That is, the key map may be a keyboard map, a 3*4 key map, and a QWERTY key map, and may be a control key map for controlling the operation of the currently activated application. In addition, the menu map may be a control key map for controlling the operation of the currently activated application. In addition, the menu map may be a menu map for controlling the operation of the currently activated application, or may be a menu map that has various menus provided by the electronic device 100 as an item. The storage unit 150 may briefly include a program area and a data area.

The program area may store an operating system (OS) for booting the electronic device 100 and operating the above-mentioned respective components, and an application for playing various files. For example, the OS may include an application for supporting a call function depending on a support of the function of the electronic device 100, a web browser for connecting to an Internet server, an MP3 application for playing sound source, an image output application for displaying a photo or the like, and a video play application, and the like.

The data area is an area where data which is generated depending on the use of the electronic device 100 is stored, and may store phone book information, at least one icon according to a widget function, and various contents. Further, the data area may store a user input provided through the display unit 140 when the display unit 140 includes an input function. According to an embodiment of the present disclosure, the storage unit 150 may store information related to a password, a pattern image, and a finger scan to activate the locked state screen.

The controller 160 may be configured to control power supplied to each component of the electronic device 100, support an initialization process, and control each component upon completion of the initialization process.

According to an embodiment of the present disclosure, the controller 160 may determine whether a touch input event is maintained in a certain area for a predetermined threshold time. In an embodiment of the present disclosure, when it is determined that a touch input event has been detected in a certain area through the display unit 140, where the touch input occurs within a predetermined effective touch area, the controller 160 may determine whether the touch input event is maintained for a predetermined threshold time.

According to an embodiment of the present disclosure, the predetermined effective touch area may be determined and changed by a developer or a user. For example, the effective touch area may be a quadrangular shape area which is 1 cm wide and 2 cm long at the bottom right of the screen, a rectangular shape area which has a 0.4 cm gap from an end area of the up down left right sides of the screen, a triangular shape area having the base of 2 cm, a circular or a semi-circular area of 2 cm radius, and a parabolic area created by a user. While various sizes and shapes have been described, one of ordinary skill in the art would recognize that the predetermined effective touch area may be determined to have any size or shape. In an embodiment of the present disclosure, the effective touch area may be changed by the user using an effective touch area program stored in the storage unit 150. Alternatively, the effective touch area may be changed and stored by downloading and executing a separate application not previously stored in the storage unit 150.

According to an embodiment of the present disclosure, when it is determined that a certain area where a touch input event is detected is not included in the predetermined effective touch area, the controller 160 may not perform a separate function. For example, the controller 160 may disregard the detected input outside the predetermined effective touch area and control to maintain a locked state.

According to an embodiment of the present disclosure, a predetermined threshold time may be determined and changed by a developer or a user. For example, the predetermined threshold time may be determined and changed to be 0.5 second, 1 second, 1.5 seconds, or the like by the user.

According to an embodiment of the present disclosure, the controller 160 may control the display unit 140 to display a user interface that provides a predetermined function on the screen based on the result of the determination on whether the touch input event is maintained. For example, when it is determined that the touch input event is maintained for a predetermined threshold time, the controller 160 may control the display unit 140 to display a user interface that provides the predetermined function on the screen.

According to an embodiment of the present disclosure, the controller 160 may control the pre-stored standby screen user interface based on the result of the determination on whether the touch input event is maintained. In this case, the pre-stored standby screen may be a standby screen of the electronic device 100, a pre-stored screen which is displayed when the touch input event is maintained for the predetermined threshold time, or the like. For example, the controller 160 may control the display unit 140 to display a standby screen user interface “A” while the touch input event is maintained and control the display unit 140 to display the standby screen user interface “B” when a home key input is detected.

According to an embodiment of the present disclosure, the controller 160 may switch the screen to an active state and may maintain the displayed standby screen user interface when at least one of a drag input event, a flip input event, a flick input event, or a swipe input event is detected while the touch input event is maintained. According to an embodiment of the present disclosure, the controller 160 may switch the locked state screen to an active state when the drag input event, the flip input event, the flick input event, and the swipe input event exceed a predetermined threshold distance or reaches an edge of the up, down, left, and right of the predetermined effective touch area.

According to an embodiment of the present disclosure, the controller 160 may change at least one of brightness information, color information, or chroma information of the user interface displayed while the touch input event is maintained, and the brightness information, the color information, and the chroma information of the displayed user interface after the screen has been switched to the active state (e.g., unlocked). For example, while the touch input event is maintained, the brightness information of the user interface state may include data having lower brightness than the brightness information of the displayed user interface switched to the active state of the screen. In addition, a user may adjust the brightness information, the color information, and the chroma information of the user interface which is to be displayed while the touch input event is maintained which may be helpful in the power consumption and the battery consumption of the electronic device 100.

According to an embodiment of the present disclosure, when a touch release event for releasing the touch input event is detected after displaying the user interface, the controller 160 may control the screen not to display the user interface. For example, when the standby screen user interface is displayed on the screen, the controller 160 may prevent the user interface which has been displayed from being displayed when a touch release event which is a threshold distance or more away from the screen is detected.

According to an embodiment of the present disclosure, the controller 160 may be configured to control the display unit 140 to display an image item in a certain area where the touch input event is detected based on the result of the determination on whether the touch input event is maintained in a certain area of the screen. For example, the controller 160 may check the location area where the touch input event is detected, and control the display unit 140 to display the image item in the checked location area. In this case, the image item may be a thumbnail image having an image form corresponding to a pertinent function in order to perform the pre-stored function, a shortcut, a function control display icon, a user interface of a releasable pattern form or a password type, and a function performing display icon, and the like. For example, when the image item is a text image item corresponding to a function that can check and transmit and receive a text message, it may be a thumbnail image having a “Text” icon.

According to an embodiment of the present disclosure, the controller 160 may control the display unit 140 to display the image item corresponding to at least one of text message data, video data, call data or audio data received from the external device. For example, in the state in which the text message data has been received from the external device (e.g., other portable terminal (not shown), a server, etc.), when the touch input event is maintained for a predetermined threshold time, the controller 160 may control the display unit 140 to display the image item corresponding to the text message data in a certain area where the touch input event is detected. For example, the image item may include information on the amount of text message data and information on whether the message has already been viewed by the user.

According to an embodiment of the present disclosure, the controller 160 may determine the reception time of data when receiving data from an external device through the communication unit 110. The controller 160 may check and compare the reception time of each data transmission when receiving two or more data transmissions from the external device through the communication unit 110. According to an embodiment of the present disclosure, when receiving at least two data transmissions from the external device through the communication unit 110, the controller 160 may be configured to determine the data received in the nearer time from a time when the touch input event is detected and display the image item corresponding to the checked data in a certain area of the locked state of screen where the touch input event is detected. Here, the data received by the communication unit 110 may be the text message data, the video data, the call data, and the audio data, and the like.

For example, when text message data is received at 3:00 pm and the SNS data is received at 3:04 pm through the communication unit 110, when the touch input event is detected in a certain area of the locked state of screen at 3:07 pm, the controller 160 may control the display unit 140 to display the image item corresponding to the SNS data in a certain area where the touch input event is detected.

According to an embodiment of the present disclosure, the controller 160 may control the display unit 140 to display any one image item among a pattern image item, a password image item, and/or a finger scan image item that provide a function of releasing the locked state of screen.

According to an embodiment of the present disclosure, the controller 160 may check a predetermined pattern form that can release the locked state of screen when displaying the pattern image item which provides the function of releasing the locked state of screen in a certain area where the touch input event is detected. According to an embodiment of the present disclosure, the controller 160 may control the display unit 140 to display the image item corresponding to a first pattern among the checked pattern form. For example, the controller 160 may control the display unit 140 to display the upper left area of pattern form in a certain area where the touch input event is maintained when the form of the predetermined pattern that can release the locked state of screen is a form of giyeok (“ [symbol] ”) where the upper left area is connected to the lower right area.

According to an embodiment of the present disclosure, the controller 160 may be configured to check the pre-stored password to release the locked state of screen and display the image item corresponding to a first password numeric among the checked password in the certain area of the display unit 140 where the touch input event is maintained. For example, when the checked password is “4321”, the controller 160 may display the image item corresponding to “4” in a certain area in which the touch input event is maintained. Thereafter, when the selection of the image item corresponding to “3” is detected, the controller 160 may control to display the image item corresponding to “3” in a certain area in which the touch input event is maintained. Thereafter, the controller 160 may control to display the image item corresponding to “2” and “1” in a certain area in which the touch input event is maintained.

According to an embodiment of the present disclosure, the display unit 140 may detect a movement input event which is changed according to the movement of the touch input event which is maintained in the image item. For example, the display unit 140 may detect that a touch input event is changed from the upper left portion to the lower right portion in the effective touch area where the touch input event is maintained. According to an embodiment of the present disclosure, the controller 150 may control to move and display the image item in a certain area of the screen of the display unit 140 corresponding to the detected movement input event.

According to an embodiment of the present disclosure, the electronic device 100 may include a finger scan sensor (not shown). The finger scan sensor (not shown) may be an input image device for obtaining a fingerprint image (or image information associated with a fingerprint) that represents a unique characteristic for each user. Sensing data for the fingerprint image may be obtained by an optical type, a semiconductor type, an ultrasonic type or a non-contact type.

An optical finger scan sensor may include, for example, a prism, a light source, a lens or a charge coupled device (CCD), or the like. In the optical sensor, a light source emits a light to the prism when the fingerprint is in contact with the prism, the lens collects the light reflected by the prism, and the CCD may obtain the collected light as a fingerprint image.

A semiconductor finger scan sensor may include a thermal sensor, a capacitive sensor, an electric field sensor, or the like. The semiconductor finger scan sensor may be miniaturized and may be used to applied products for a personal use.

The thermal sensor may be a finger scan sensor that obtains a temperature distribution as the fingerprint image through the temperature difference between the contact area and the non-contact area of the fingerprint. The capacitive sensor may be a finger scan sensor that obtains a difference of the quantity of electrical charge or the capacitance charged between the ridges of the touched fingerprint as the fingerprint image. The electric field sensor may be a finger scan sensor that obtains fingerprint image information from the electric field formed by the fingerprint in contact with the sensor or formed in the vicinity of the fingerprint.

Meanwhile, the finger scan sensor (not shown) may include at least a portion of the controller 160. For example, the finger scan sensor (not shown) may include an operation such as an operation of correcting the fingerprint image or an operation of calculating the characteristic of the fingerprint image, in addition to an operation of obtaining the fingerprint image. In this case, the finger scan sensor (not shown) may be a functional module having a hardware module and a software module.

Such a finger scan sensor (not shown) may be mounted in one side of a housing of the electronic device 100. In addition, the finger scan sensor (not shown) may have a configuration combined with a key of the electronic device 100. For example, the finger scan sensor (not shown) may be physically coupled to a home button which is an example of the key, and one side of the finger scan sensor (not shown) may be exposed on the home button. Other finger scan sensor (not shown) may be mounted in the electronic device 100 in various configurations in consideration of user's use habits and the ease of operation.

According to an embodiment of the present disclosure, when the touch input event is maintained in a certain area of the screen for a predetermined time, it is possible to display a finger scan image item to perform finger scan in a certain area. The controller 160 may be configured to compare a user's fingerprint previously stored in the storage unit 150 with the fingerprint detected through a certain area of the screen and activate the screen.

According to an embodiment of the present disclosure, the controller 160 may control the display unit 140 to display the image item that can execute a pre-stored application. Here, the pre-stored application may include one or more applications and may be set by a user. According to an embodiment of the present disclosure, the controller 160 may determine the frequency at which each application is activated by a user and decide which application to display based on the determined activation frequency.

For example, when the activation frequency of the Internet application or the social network service (SNS) application is higher than the activation frequency of the call application, the controller 160 may display the image item corresponding to the Internet application or the SNS application in a certain area where the touch input event is maintained. In another example, the controller 160 may analyze the use history of the application in user's electronic device 100, and display the application which is activated in a near time from the time during which the touch input event is maintained. In yet another example, the controller 160 may determine the battery state of the electronic device 100, and display an application (e.g., a 3D game, a high definition video, etc.) requiring a high power processor when the battery state exceeds a predetermined threshold battery state or and display an application (e.g., memo, weather, etc) requiring a low power processor when the battery state is less than a predetermined threshold battery state.

According to an embodiment of the present disclosure, the controller 160 may control the display unit 140 to display the image item that can control an audio function in a certain area in which the touch input event is detected when it is determined that the audio function of the electronic device is activated. According to an embodiment of the present disclosure, when an audio function is outputted and the touch input event is maintained in a certain area of the screen for a predetermined threshold time, the controller 160 may control the display unit 140 to display the image item that can control the audio function in a certain area in which the touch input event is detected.

For example, the image item may be an image item to provide a playing function of an audio data, an image item to provide a function of temporarily pausing audio data, an image item to provide a function of moving to the next audio data file or to the previous audio data file when a plurality of audio data files exist, and an image item corresponding to the explanation of audio data, the total length, and the currently playing section compared to the total length.

The vibration unit 170 may perform various vibrations under the control of the controller 160, and, to this end, the vibration unit 170 may include at least one vibration motor. The vibration unit 170 may be activated when a call signal is received in a silent vibration mode or the alarm time has arrived according to user settings.

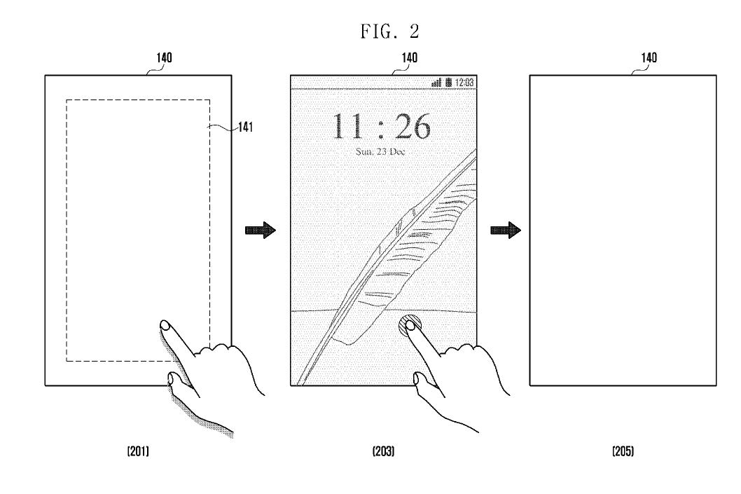

FIG. 2 is a schematic diagram illustrating an operation of controlling a display of user interface in an electronic device 100 according to various embodiments of the present disclosure.

Referring to FIG. 2, according to an embodiment of the present disclosure, when the display unit 140 includes input capabilities, a touch input event may be detected in a certain area of the locked state of screen. Referring to <201>, the touch input event may be detected within an effective touch area 141. According to an embodiment of the present disclosure, the input device associated with the display unit 140 may recognize that an object is approaching the display by detecting a current change due to the object as the object moves toward the display unit 140. For example, the touch input event may be recognized and detected using finger hovering technology. However, any other touch input recognition and detection techniques may be used.

Referring to <203>, when it is determined that the touch input event is maintained for a predetermined threshold time, the controller 160 may control the display unit 140 to display a user interface that provides a pre-set function on the screen. The user interface may be a pre-stored standby screen user interface of the electronic device 100, a separate user interface corresponding to the maintained touch input event, and the like. For example, as illustrated at <203>, the pre-stored standby screen can include the current date, time, and an image such as a quill. However, the pre-stored standby screen can include any information or pre-stored image.

Referring to <205>, when a touch release event for releasing the touch input event is detected, the controller 160 may control the display unit 140 to discontinue displaying the user interface on the screen. For example, if the object which performed a touch input is a predefined threshold distance or more away from the display unit 140, the controller 160 may control the display unit 140 to discontinue displaying the user interface.

It is noted that the detected touch inputs may be detected by the display unit 140 or by the controller 160 based on an input signal generated by the display device 140 corresponding to the touch inputs.

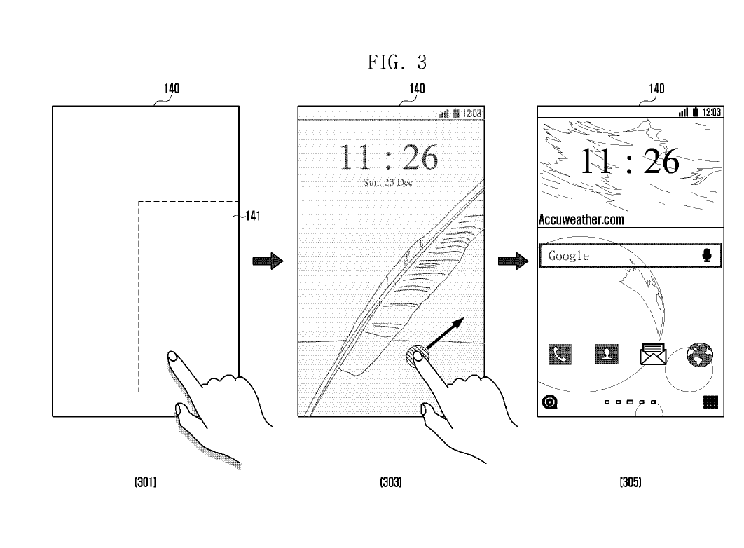

FIG. 3 is a schematic diagram illustrating an operation of controlling a display of user interface in an electronic device 100 according to various embodiments of the present disclosure.

Referring to FIG. 3, according to an embodiment of the present disclosure, when the display unit 140 includes input capabilities, a touch input event may be detected in a certain area of the locked state of screen. Referring to <301>, the touch input event within a certain area of the effective touch area 141 may be detected. According to an embodiment of the present disclosure, the input device associated with the display unit 140 may recognize that an object is approaching the display by detecting a current change due to the object as it moves toward the display unit 140. For example, the touch input event may be recognized and detected using finger hovering technology.

Referring to <303>, when it is determined that the touch input event is maintained for a predetermined threshold time, the controller 160 may control the display unit 140 to display a user interface that provides a pre-set function on the screen. The user interface may be a pre-stored standby screen user interface of the electronic device 100, a separate user interface corresponding to the maintained touch input event, and the like. For example, the controller 160 may control the display unit 140 to display the image item distinguished from the displayed standby screen user interface in a location area where the touch input event is detected.

Referring to <305>, while the touch input event is maintained for a predetermined amount of time and at least one of the drag input event, the flip input event, the flick input event, or the swipe input event is detected, the controller 160 may switch the screen to the active state and may maintain the displayed standby screen user interface.

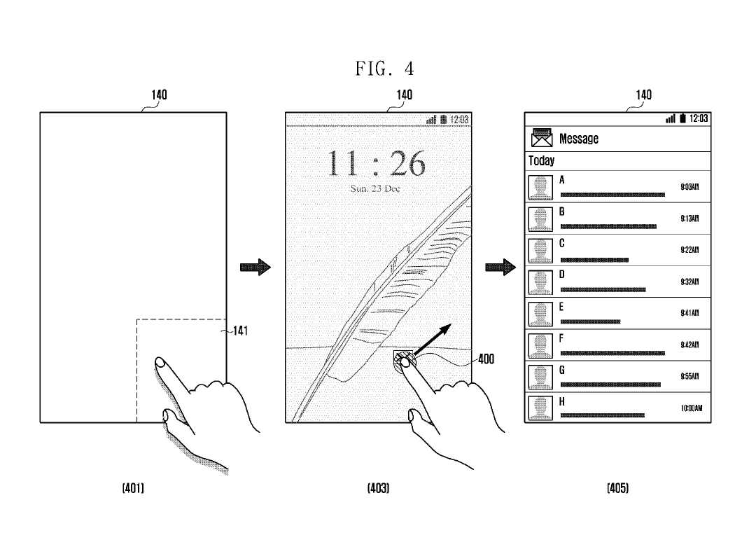

FIG. 4 to FIG. 8 are schematic diagrams illustrating an operation of controlling a display of image item in an electronic device according to various embodiments of the present disclosure.

Referring to FIG. 4, according to an embodiment of the present disclosure, when the display unit 140 includes input capabilities, a touch input event may be detected in a certain area of the locked state of screen. Referring to <401>, the touch input event may be detected within the effective touch area 141. According to an embodiment of the present disclosure, the input device associated with the display unit 140 may recognize that an object is approaching the display by detecting a current change due to the object as it moves toward the display unit 140. For example, the touch input event may be recognized and detected using finger hovering technology.

Referring to <403>, when it is determined that the touch input event is maintained for a predetermined threshold time, the controller 160 may control the display unit 140 to display an image item in a certain area where the touch input event is detected. The image item may be an image item 400 corresponding to text message data received from an external device. According to an embodiment of the present disclosure, the controller 160 may control the display unit 140 to detect the movement input event which is changed according to the movement of the touch input event and display the image item 400 corresponding to text message data in a certain area of the screen corresponding to the detected movement input event.

Referring to <405>, in the state in which the touch input event is maintained, when at least one of the drag input event, the flip input event, the flick input event, or the swipe input event is detected, the controller 160 may control the display unit 140 to display an entire screen of the image item 400 corresponding to text message data.

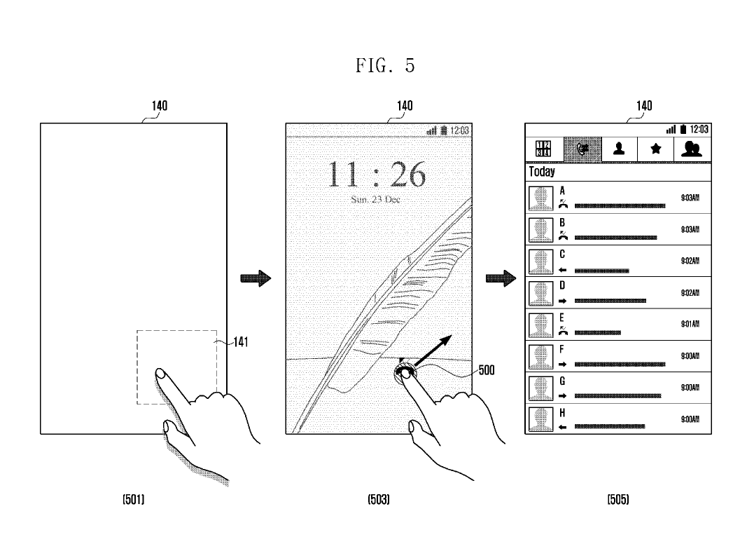

Referring to FIG. 5, according to an embodiment of the present disclosure, the touch input event may be detected in a certain area of the locked state of screen. Referring to <501>, the display unit 140 may detect the touch input event for a certain area of the effective touch area 141. According to an embodiment of the present disclosure, the display unit 140 may recognize that an object is approaching by detecting a current change due to the object which moves toward the display unit 140. For example, the display unit 140 may recognize and detect the touch input event through finger hovering technology.

Referring to <503>, when it is determined that the touch input event is maintained for a predetermined threshold time, the controller 160 may control the display unit 140 to display an image item in a certain area where the touch input event is detected. Here, the image item may be an image item 500 corresponding to the call data received from the external device. According to an embodiment of the present disclosure, the control unit 160 may control the display unit 140 to display the image item 500 corresponding to the call data in the area where the touch input event is detected. According to an embodiment of the present disclosure, the control unit 160 may detect the movement input event which is changed according to the movement of the touch input event and display the image item 500 corresponding to the call data in a certain area of the screen corresponding to the detected movement input event.

Referring to <505>, in the state in which the touch input event is maintained, when at least one of the drag input event, the flip input event, the flick input event, or the swipe input event is detected, the controller 160 may control the display unit 140 to display an entire screen of the image item 500 corresponding to the call data. For example, the entire screen of the image item 500 corresponding to the call data may include a call record, a call record time, and the like.

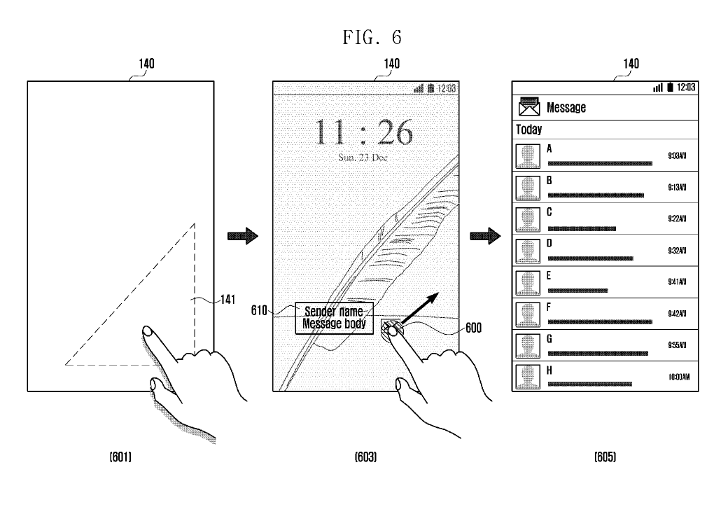

Referring to FIG. 6, according to an embodiment of the present disclosure, the touch input event may be detected in a certain area of the locked state of screen. Referring to <601>, the display unit 140 may detect the touch input event for a certain area of the effective touch area 141. According to an embodiment of the present disclosure, the display unit 140 may recognize that an object is approaching by detecting a current change due to the object which moves toward the display unit 140. For example, the display unit 140 may recognize and detect the touch input event through finger hovering technology.

Referring to <603>, when it is determined that the touch input event is maintained for a predetermined threshold time, the controller 160 may control the display unit 140 to display an image item in a certain area where the touch input event is detected. According to an embodiment of the present disclosure, the controller 160 may control the display unit 140 to display an image information item 610 including information related to an image item 600 displayed within a threshold distance area from an area where the touch input event is detected. In this case, the image item may be the image item 600 corresponding to the text data received from the external device. The image information item 610 may include a name of a sender who sent the received text data, a text message title, and a portion of content included in the text data.

According to an embodiment of the present disclosure, the display unit 140 may detect the movement input event which is changed according to the movement of the touch input event and display the image item 600 corresponding to the call data in a certain area of the screen corresponding to the detected movement input event.

Referring to <605>, in the state in which the touch input event is maintained, when at least one of the drag input event, the flip input event, the flick input event, or the swipe input event is detected, the controller 160 may control the display unit 140 to display an entire screen of the image item 600 corresponding to text message data.

According to an embodiment of the present disclosure, the controller 160 may check the reception time associated with when a data transmission was received from the external device through the communication unit 110. The controller 160 may check and compare the reception time of each data transmission when receiving two or more data transmissions from the external device through the communication unit 110. According to an embodiment of the present disclosure, when receiving at least two data transmissions from the external device through the communication unit 110, the controller 160 may be configured to determine the data transmission received nearer in time from a time when the touch input event is detected and display the image item corresponding to the determined data transmission in a certain area of the locked state of screen where the touch input event is detected. The data received by the communication unit 110 may be a text message data transmission, a video data transmission, a call data transmission, and an audio data transmission, and the like.

For example, when the text message data is received at 4:00 pm and the SNS data is received at 4:04 pm through the communication unit 110, when the touch input event is detected in a certain area of the locked state of screen at 4:07 pm, the controller 160 may control the display unit 140 to display the image item corresponding to the SNS data in a certain area where the touch input event is detected.

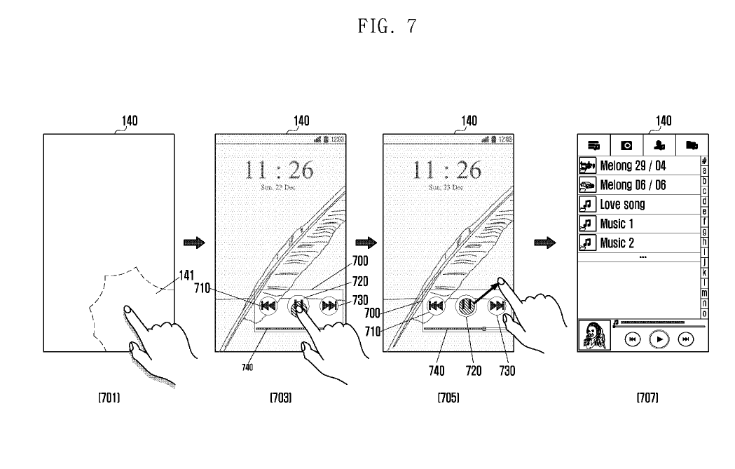

Referring to FIG. 7, according to an embodiment of the present disclosure, the display unit 140 may detect the touch input event in a certain area of the locked state of screen.

Referring to <701>, the touch input event for a certain area of the effective touch area 141 may be detected. According to an embodiment of the present disclosure, the display unit 140 may recognize that an object is approaching by detecting a current change due to the object which moves toward the display unit 140. For example, the display unit 140 may recognize and detect the touch input event through finger hovering technology.

Referring to <703>, when it is determined that the touch input event is maintained for a predetermined threshold time, the controller 160 may control the display unit 140 to display an image item in a certain area where the touch input event is detected. The image item may be an image item 700 associated with the control an audio function.

According to an embodiment of the present disclosure, the controller 160 may control the display unit 140 to display a certain area where the touch input event is detected distinguished from an area where the touch input event is not detected. For example, the controller 160 may control the display unit 140 to display the certain area where the touch input event is detected in such a manner that the certain area has a circular, a semicircular, or a polygonal shape, or has different brightness information, chroma information, or the like from the certain area where the touch input event is not detected. For another example, the controller 160 may control the display unit 140 to display an arrow user interface having a form of moving in the directions of north, south, east and west, based on the certain area where the touch input event is detected.

According to an embodiment of the present disclosure, the controller 160 may control the display unit 140 to display an image item 720 that can perform an audio play function and pause the audio play function in the certain area where the touch input event is detected.

According to an embodiment of the present disclosure, the controller 160 may perform an audio play function or pause the audio play function, based on the touch input event which is maintained in the displayed image item 720 for a predetermined threshold time. For example, while the audio is played, the controller 160 may perform a pause function of the audio play, when the touch input event is maintained in the image item 720 for the threshold time.

According to an embodiment of the present disclosure, the controller 160 may control the display unit 140 to change and display the image item that performs the audio play function and the image item corresponding to the pause function of the audio play based on the time during which the touch input event is maintained in the image item 720. For example, while the audio function of the electronic device 100 is performed, the controller 160 may control to display the image item that performs the audio play function and change the displayed image item of play function into the image item corresponding to the pause function of the audio play when the touch input event is maintained for a predetermined threshold time in the displayed image item. According to an embodiment of the present disclosure, the item image 700 may include at least one of a play image item 720 that provides a function of outputting an audio or pausing the audio, a previous audio image item 710 that can output audio data which is prior to the audio data that is currently outputted when a plurality of audio data exist, a next audio image item 730 that can output audio data after the audio data that is currently outputted when a plurality of audio data exist, or a section selection image item 740 that can decide an output section of the audio data.

Referring to <705>, the display unit 140 may detect at least one of the drag input event, the flip input event, the flick input event, or the swipe input event, not in a direction of an area in which the image item 700 that can control the audio function is displayed while the touch input event is maintained.

Referring to <707>, when at least one of the drag input event, the flip input event, the flick input event, or the swipe input event is detected, the controller 160 may control the display unit 140 to display an entire screen associated with the image item 700 which can control an audio function. For example, the controller 160 may control to display an entire screen of an application that provides music data, and video data.

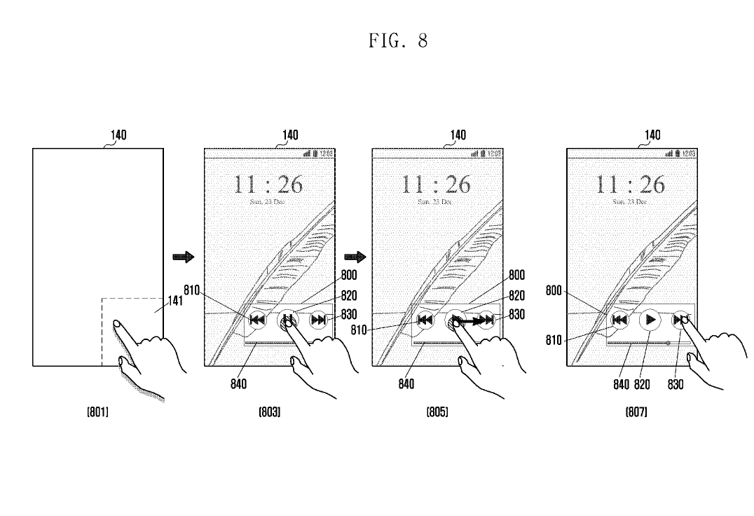

Referring to FIG. 8, according to an embodiment of the present disclosure, the display unit 140 may detect the touch input event in a certain area of the locked state of screen.

Referring to <801>, the touch input event for a certain area of the effective touch area 141 may be detected. According to an embodiment of the present disclosure, the display unit 140 may recognize that an object is approaching by detecting a current change due to the object which moves toward the screen. For example, the display unit 140 may recognize and detect the touch input event through finger hovering technology.

Referring to <803>, when it is determined that the touch input event is maintained for a predetermined threshold time, the controller 160 may control the display unit 140 to display an image item in a certain area where the touch input event is detected. The image item may be an image item 800 that can control an audio function. According to an embodiment of the present disclosure, the controller 160 may control the display unit 140 to display an image item 820 that can perform an audio play function and pause the audio play function in a certain area where the touch input event is detected.

According to an embodiment of the present disclosure, the controller 160 may control the display unit 140 to display a certain area where the touch input event is detected distinguished from an area where the touch input event is not detected. For example, the controller 160 may control the display unit 140 to display the certain area where the touch input event is detected as a circular, a semicircular, or a polygonal shape. For example, the controller 160 may control the display unit 140 to display an arrow user interface having a form of moving in the directions of north, south, east and west based on the certain area where the touch input event is detected.

According to an embodiment of the present disclosure, the controller 160 may control the display unit 140 to display an image item 820 that performs an audio play function and pause the audio play function in the certain area where the touch input event is detected.

According to an embodiment of the present disclosure, the controller 160 may perform an audio play function or pause the audio play function, based on the touch input event which is maintained in the displayed image item 820 for a predetermined threshold time. For example, while the audio is played, the controller 160 may perform a pause function of the audio play when the touch input event is maintained in the image item 820 for the threshold time.

According to an embodiment of the present disclosure, the controller 160 may control the display unit 140 to change and display the image item that performs the audio play function and the image item corresponding to the pause function of the audio play based on the time during which the touch input event is maintained in the image item 820. For example, while the audio function of the electronic device 100 is performed, the controller 160 may control the display unit 140 to display the image item that performs the audio play function and display the displayed image item of play function into the image item corresponding to the pause function of the audio play when the touch input event is maintained for a predetermined threshold time in the displayed image item. According to an embodiment of the present disclosure, the item image 800 may include at least one of a play image item 820 that provides a function of outputting an audio or pausing the audio, a previous audio image item 810 that can output audio data which is prior to the audio data that is currently outputted when a plurality of audio data exist, a next audio image item 830 that can output audio data after the audio data that is currently outputted when a plurality of audio data files exists, or a section selection image item 840 that can decide an output section of the audio data.

Referring to <805>, the display unit 140 may detect at least one of the drag input event, the flip input event, the flick input event, or the swipe input event, in a direction of an area in which the previous audio image item 810 or the next audio image item 830 is displayed with respect to the maintained touch input event.

Referring to <807>, when at least one of the drag input event, the flip input event, the flick input event, or the swipe input event is detected in a certain area where the next audio image item 830 is displayed, the controller 160 may control the display unit 140 to display an entire screen of the image item 600 which can control the output of the audio data after the currently outputted audio data terminates. For example, when the order in which a plurality of music files are to be played is determined and an input event (e.g., the drag input event, the drag and drop input event, the flick input event, the flip input event, the swipe input event, or the like) for the next audio image item 830 is detected in the state in which a first music file is played, the controller 160 may control to output a second music file.

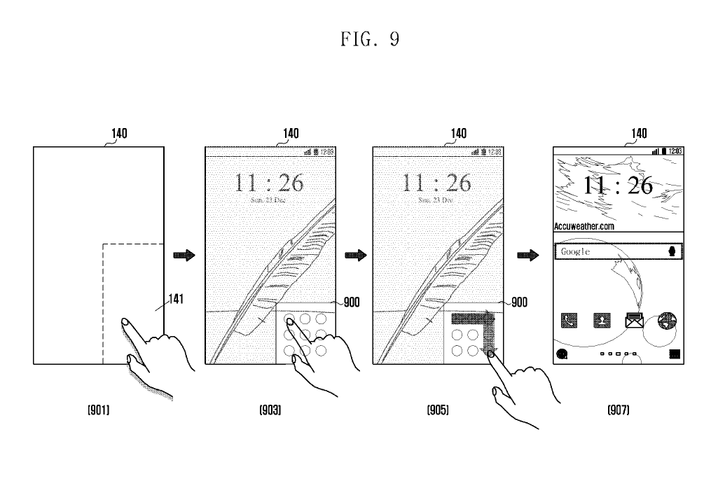

FIG. 9 to FIG. 11 are schematic diagrams illustrating an operation of controlling a display of image item 900, 1000, 1100 providing a lock release function in an electronic device 100 according to various embodiments of the present disclosure.

Referring to FIG. 9 at <901>, the display unit 140 may detect the touch input event for a certain area of the effective touch area 141. According to an embodiment of the present disclosure, the display unit 140 may recognize that an object is approaching by detecting a current change due to the object which moves toward the screen. For example, the display unit 140 may recognize and detect the touch input event through finger hovering technology.

Referring to <903>, when it is determined that the touch input event is maintained for a predetermined threshold time, the controller 160 may control the display unit 140 to display an image item in a certain area where the touch input event is detected. The image item may be a pattern image item 900 that provides a function of releasing the locked state of screen. According to an embodiment of the present disclosure, the controller 160 may check a predetermined pattern form that can release the locked state of screen and control the display unit 140 to display the pattern image item in a certain area where the touch input event is maintained based on the checked pattern form. For example, the controller 160 may control the display unit 140 to display a first pattern form of the checked pattern form in the area where the touch input event is maintained.

According to an embodiment of the present disclosure, the controller 160 may check a predetermined pattern form that can release the locked state of screen when displaying a pattern image item which provides the function of releasing the locked state of screen in a certain area where the touch input event is detected. According to an embodiment of the present disclosure, the controller 160 may control the display unit 140 to display the image item corresponding to a first pattern among the checked pattern. For example, the controller 160 may control the display unit 140 to display the upper left area of pattern form in a certain area where the touch input event is maintained when the form of the predetermined pattern that can release the locked state of screen is a form of giyeok (“ [symbol] ”) where the upper left area is connected to the lower right area.

Referring to <905>, the display unit 140 may detect the pattern form input having the form of giyeok (“ [symbol] ”) from the upper left area of pattern form to the lower right area. Referring to <907>, when the form of the predetermined pattern is identical with the inputted user pattern as a result of comparison, the controller 160 may control the display unit 140 to display the standby screen user interface previously stored in the electronic device 100.

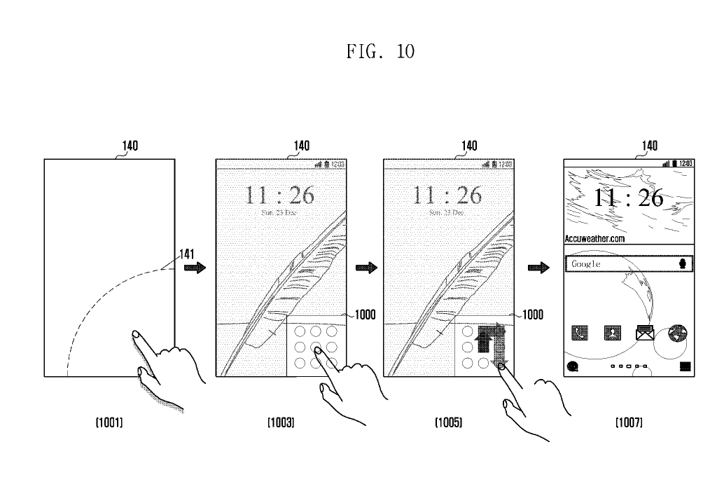

FIG. 10 is a schematic diagram illustrating an operation of controlling a display of image item 1000 providing a lock release function in an electronic device 100.

Referring to FIG. 10 at <1001>, the touch input event for a certain area of the effective touch area 141 may be detected. According to an embodiment of the present disclosure, the display unit 140 may recognize that an object is approaching by detecting a current change due to the object which moves toward the display unit 140. For example, the display unit 140 may recognize and detect the touch input event through finger hovering technology.

Referring to <1003>, when it is determined that the touch input event is maintained for a predetermined threshold time, the controller 160 may control the display unit 140 to display an image item in a certain area where the touch input event is detected. The image item may be a pattern image item 1000 that provides a function of releasing the locked state of screen. According to an embodiment of the present disclosure, the controller 160 may check a predetermined pattern form that can release the locked state of screen and control the display unit 140 to display the pattern image item in a certain area where the touch input event is maintained based on the checked pattern form. For example, the controller 160 may control the display unit to display a first pattern form of the checked pattern form in the area where the touch input event is maintained.

Referring to <1005>, the display unit 140 may detect the pattern form input having the form which is connected from the central area of the pattern form to the central area of the upper right, the right area of the upper right, and the right area of the lower left. Referring to <1007>, when the form of the predetermined pattern is identical with the inputted user pattern as a result of comparison, the controller 160 may control the display unit 140 to display the standby screen user interface previously stored in the electronic device 100.

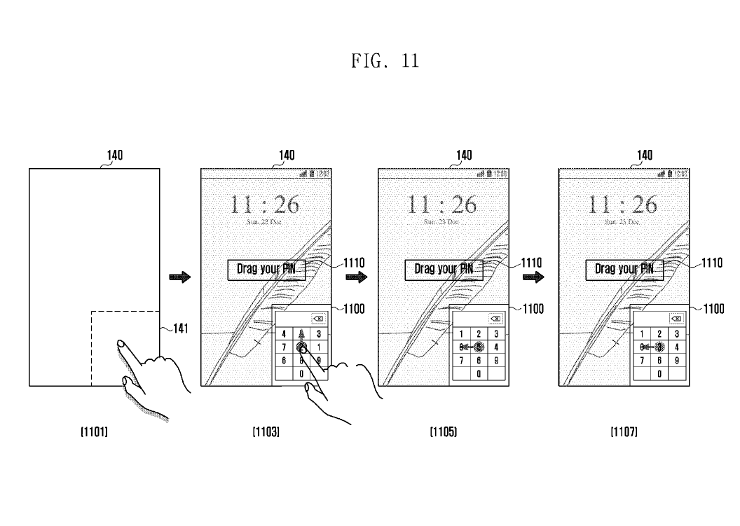

FIG. 11 is a schematic diagram illustrating an operation of controlling a display of image item 1100 providing a lock release function in an electronic device 100.

Referring to FIG. 11 at <1101>, the touch input event for a certain area of the effective touch area 141 may be detected. According to an embodiment of the present disclosure, the display unit 140 may recognize that an object is approaching by detecting a current change due to the object which moves toward the display unit 140. For example, the display unit 140 may recognize and detect the touch input event through finger hovering technology.

Referring to <1103>, when it is determined that the touch input event is maintained for a predetermined threshold time, the controller 160 may control the display unit 140 to display an image item in a certain area where the touch input event is detected. According to an embodiment of the present disclosure, the control unit 160 may control the display unit 140 to display an image explanation item 1110 including information that explains a control method for an image item. The image item may be a password image item 1100 that provides a function of releasing the locked state of screen. According to an embodiment of the present disclosure, the controller 160 may check a pre-stored password that can release the locked state of screen and control the display unit 140 to display the image item corresponding to a first password numeric of the checked password in a certain area where the touch input event is maintained. For example, the controller 160 may control the display unit 140 to display the image item corresponding to “2” which is the first numeric of the password in the area where the touch input event is maintained. Then, the display unit 140 may detect a touch input event for the image item corresponding to “5” which is the second numeric of the password.

Referring to <1105>, the controller 160 may determine the arrangement of the image item corresponding to the numeric to be displayed based on the checked password. For example, if the third numeric of password is “8”, the controller 160 may control the display unit 140 to display the numeric in any one area of the up, down, left, and right areas of the image item corresponding to “5” which is the second numeric of the password. For another example, the display 140 may detect the movement input event in all directions and the movement input event in a diagonal direction.

For another example, if the number of image item of “1”, “2”, “3”, “4”, “5”, “6”, “7”, “8”, “9”, and “0” is 1, the numeric of the password to be displayed may be configured in such a manner that the number of image item of “1” is 3, the number of image item of “3” is 4, and the number of image items of “4”, “5”, “6”, “7”, “8”, “9”, and “0” is 1 or 0.

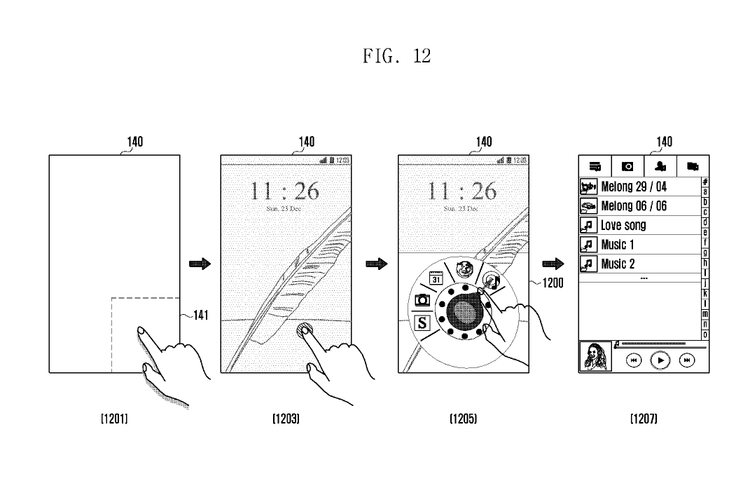

FIG. 12 is a schematic diagram illustrating an operation of controlling a display of image item 1200 providing a lock release function in an electronic device 100.

Referring to FIG. 12 at <1201>, the touch input event for a certain area of the effective touch area 141 may be detected. According to an embodiment of the present disclosure, the display unit 140 may recognize that an object is approaching by detecting a current change due to the object which moves toward the display unit 140. For example, the display unit 140 may recognize and detect the touch input event through finger hovering technology.

Referring to <1203> and <1205>, when it is determined that the touch input event is maintained for a predetermined threshold time, the controller 160 may control the display unit 140 to display an image item in a certain area where the touch input event is detected. The image item may be an image item 1200 that can execute a pre-stored application. In this case, the pre-stored application may be configured of a plurality of applications and may be set by a user.

According to an embodiment of the present disclosure, the controller 160 may decide the application to be displayed by determining the frequency at which the application is activated by the user. For example, when the activation frequency of the Internet application or the social network service (SNS) application is higher than the activation frequency of the call application, the controller 160 may display the image item corresponding to the Internet application or the SNS application in the area where the touch input event is maintained. For another example, the controller 160 may analyze the use history of the application in electronic device 100 and display the application which is activated most recently with respect to the time in which the touch input event is maintained.

Referring to <1207>, with respect to the displayed image item 1200, when at least one of the drag input event, the flip input event, the flick input event, or the swipe input event is detected, the controller 160 may control the display unit 140 to display an entire screen corresponding to the displayed image item.

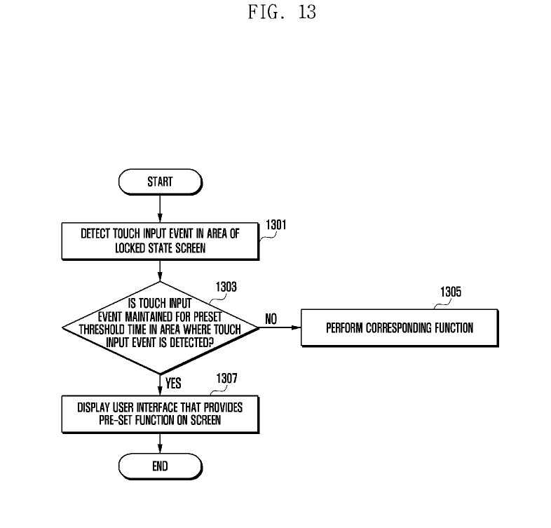

FIG. 13 is a flowchart illustrating a process of activating a user interface in an electronic device 100 according to various embodiments of the present disclosure.

According to an embodiment of the present disclosure, at operation 1301, a touch input event in a certain area of the locked state screen may be detected. For example, the display unit 140 may detect the touch input event or the display unit 140 may generate and transmit an indication associated with the touch input event to controller 160 where controller 160 determines that a touch input event has occurred.

When it is determined that a certain area where the touch input event is detected is included in a predetermined effective touch area, the controller 160 may determine whether the touch input event is maintained for a predetermined threshold time in the certain area where the touch input event is detected at operation 1303.

When it is determined that the touch input event is not maintained for a predetermined threshold time in the certain area where the touch input event is detected, the controller 160 may perform a corresponding function at operation 1305. For example, the controller 160 may maintain the locked state screen.

When it is determined that the touch input event is maintained for a predetermined threshold time in the certain area where the touch input event is detected, the controller 160 may control the display unit 140 to display a user interface that provides a pre-set function on the screen at operation 1307. In this case, the user interface may be a standby screen user interface, a user interface which is separately displayed when the touch input event is maintained, or the like.

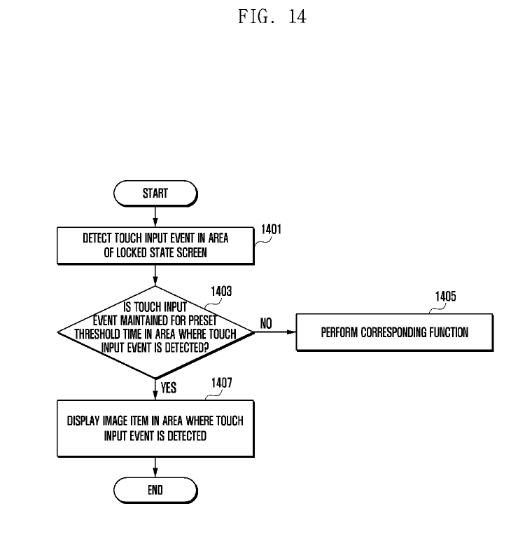

FIG. 14 is a flowchart illustrating a process of activating a user interface in an electronic device 100 according to various embodiments of the present disclosure.

According to an embodiment of the present disclosure, at operation 1401, a touch input event in a certain area of the locked state screen may be detected.

When it is determined that a certain area where the touch input event is detected is included in a predetermined effective touch area, the controller 160 may determine whether the touch input event is maintained for a predetermined threshold time in the certain area where the touch input event is detected at operation 1403. When it is determined that the touch input event is not maintained for a predetermined threshold time in the certain area where the touch input event is detected, the controller 160 may perform a corresponding function at operation 1405. For example, the controller 160 may maintain the locked state screen.

When it is determined that the touch input event is maintained for a predetermined threshold time in the certain area where the touch input event is detected, the controller 160 may display the image item in the certain area where the touch input event is detected at operation 1407.

According to an embodiment of the present disclosure, when at least one of a text message data transmission, a video data transmission, a call data transmission or an audio data transmission is received from the external device, the image item displayed in the certain area where the touch input event is detected may be an image item corresponding to the received data transmission. According to an embodiment of the present disclosure, when it is determined that the audio function is activated, the image item displayed in the certain area where the touch input event is detected may be an image item that can control the audio function. According to an embodiment of the present disclosure, the image item may be any one image item among a pattern image item, a password image item, and a finger scan image item that provide a function of releasing the locked state of screen.

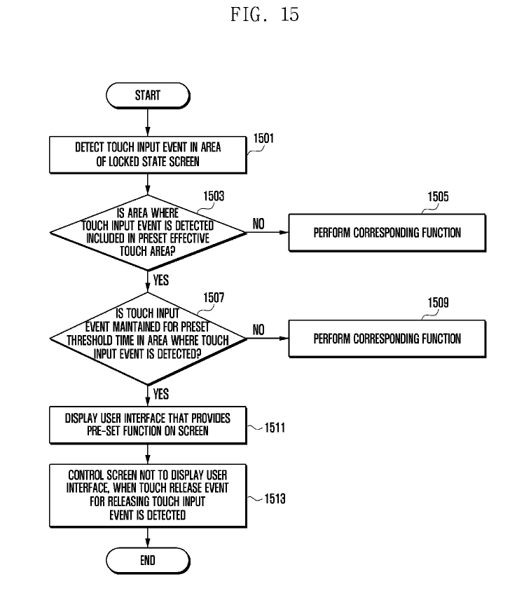

FIG. 15 is a flowchart illustrating a process of activating a user interface in an electronic device 100 according to various embodiments of the present disclosure.

According to an embodiment of the present disclosure, at operation 1501, a touch input event in a certain area of the locked state screen may be detected. At operation 1503, the controller 160 may determine whether a certain area where the touch input event is detected is included in a predetermined effective touch area. According to an embodiment of the present disclosure, the effective touch area may be changed by the user by using an effective touch area program stored in the storage unit 150 or the effective touch area may be changed and stored by downloading and executing a separate application.

At operation 1505, when a certain area where the touch input event is detected is not included in a predetermined effective touch area, the controller 160 may perform a corresponding function. For example, the controller 160 may maintain the locked state screen.

When it is determined that a certain area where the touch input event is detected is included in a predetermined effective touch area, the controller 160 may determine whether the touch input event is maintained for a predetermined threshold time in the certain area where the touch input event is detected at operation 1507. When it is determined that the touch input event is not maintained for a predetermined threshold time in the certain area where the touch input event is detected, the controller 160 may perform a corresponding function at operation 1509. For example, the controller 160 may maintain the locked state screen.

When it is determined that the touch input event is maintained for a predetermined threshold time in the certain area where the touch input event is detected, the controller 160 may control the display unit 140 to display a user interface that provides a pre-set function on the screen at operation 1511. When a touch release event for releasing the touch input event is detected, the controller 160 may control the screen not to display the user interface at operation 1513. For example, the controller 160 may control the display unit 140 to change the current state into the previous state (e.g., locked state, or the like) in which the touch input event is not detected.

Each of the above-discussed elements of the electronic device disclosed herein may be formed of one or more components, and its name may be varied according to the type of the electronic device. The electronic device disclosed herein may be formed of at least one of the above-discussed elements without some elements or with additional other elements. Some of the elements may be integrated into a single entity that still performs the same functions as those of such elements before integrated.

The term “module” used in embodiments of the present disclosure may refer to, for example, a “unit” including one of hardware, software, and firmware, or a combination of two or more thereof. The term “module” may be interchangeable with a term such as a unit, a logic, a logical block, a component, or a circuit. The “module” may be a minimum unit of an integrated component or a part thereof. The “module” may be a minimum unit for performing one or more functions or a part thereof. The “module” may be mechanically or electronically implemented. For example, the “module” according to the present disclosure may include at least one of an application-specific integrated circuit (ASIC) chip, a field-programmable gate arrays (FPGA), and a programmable-logic device for performing operations which has been known or are to be developed hereinafter.

According to various embodiments of the present disclosure, at least some of the devices (e.g., modules or functions thereof) or the method (e.g., operations) according to the present disclosure may be implemented by a command stored in a non-transitory computer-readable storage medium in a programming module form. When the command is executed by one or more processors (e.g., the processor 122), the one or more processors may execute a function corresponding to the command. The non-transitory computer-readable storage medium may be, for example, the memory 130. At least a part of the programming module may be implemented (e.g., executed) by, for example, the processor 210. At least a part of the programming module may include, for example, a module, a program, a routine, a set of instructions, and/or a process for performing one or more functions.

The non-transitory computer-readable recording medium may include magnetic media such as a hard disk, a floppy disk, and a magnetic tape, optical media such as a compact disc read only memory (CD-ROM) and a DVD, magneto-optical media such as a floptical disk, and hardware devices specially configured to store and perform a program instruction (for example, e.g., programming module), such as a ROM, a random access memory (RAM), a flash memory and the like. In addition, the program instructions may include high class language codes, which can be executed in a computer by using an interpreter, as well as machine codes made by a compiler. The aforementioned hardware device may be configured to operate as one or more software modules in order to perform the operation of various embodiments of the present disclosure, and vice versa.

In accordance with various embodiments of the present disclosure, there is provided a computer-readable recording medium on which a program is recorded, the program including an instruction to detect a touch input event in a certain area of the locked state screen by a display unit; an instruction to determine whether the touch input event is maintained for a predetermined threshold time by a controller; and an instruction to display a user interface that provides a pre-set function on the screen, based on the result of the determination on whether the touch input event is maintained by the controller.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of activating a user interface in an electronic device, the method comprising:
detecting a touch input event in a certain area of a locked state screen;
determining whether the touch input event is maintained for a predetermined threshold time; and
displaying a user interface that provides a pre-set function on the screen based on a result of determination on whether the touch input event is maintained.

2. The method of claim 1, wherein the displaying of the user interface comprises displaying an image item in a certain area where the touch input event is detected.

3. The method of claim 2, wherein the displaying of the image item comprises controlling to display an image item corresponding to at least one of text message data, video data, call data, and audio data received from an external device in the certain area where the touch input event is detected.

4. The method of claim 3, further comprising:
controlling to display an entire screen corresponding to the image item, when at least one of a drag input event, a flip input event, a flick input event, or a swipe input event is detected in a state in which the touch input event is maintained in the displayed image item.

5. The method of claim 2, wherein the displaying of the image item comprises:
controlling to display any one image item among a pattern image item, a password image item, and a finger scan image item that provides a function of releasing the locked state of screen, in the certain area where the touch input event is detected;
controlling to display an image item that can execute a pre-stored application, in the certain area where the touch input event is detected; and
controlling to display an image item that can control an audio function in the certain area where the touch input event is detected, when it is determined that the audio function of the electronic device is activated.

6. The method of claim 5, wherein the controlling to display the any one image item comprises:
checking a predetermined pattern form that can release the locked state of screen; and
controlling to display an image item corresponding to a first pattern among the checked pattern form, in the certain area where the touch input event is detected.

7. The method of claim 5, wherein the controlling to display the any one image item comprises:
checking a pre-stored password that can release the locked state of screen; and
controlling to display an image item corresponding to a first numeric password among the checked password, in the certain area where the touch input event is detected.

8. The method of claim 5, further comprising performing an audio output function or a pause function of audio output based on the touch input event which is maintained in an image item for a predetermined threshold time when the controller controls to display the image item that can control the audio function in the certain area where the touch input event is detected.

9. The method of claim 2, further comprising:
detecting a movement input event which is changed according to movement of the touch input event which is maintained in the image item; and
controlling to move and display the image item in a certain area of screen corresponding to the detected movement input event.

10. The method of claim 1, wherein the determining whether the touch input event is maintained for the predetermined threshold time comprises determining whether a certain area where the touch input event is detected is included in a predetermined effective touch area.

11. An electronic device comprising:
a display unit configured to detect a touch input event in a certain area of a locked state screen; and
a controller configured to:
determine whether the touch input event is maintained for a predetermined threshold time, and
display a user interface that provides a pre-set function on the screen based on a result of determination on whether the touch input event is maintained.

12. The electronic device of claim 11, wherein the controller is further configured to display an image item in a certain area where the touch input event is detected.

13. The electronic device of claim 12, wherein the controller is further configured to control to display an image item corresponding to at least one of text message data, video data, call data, and audio data received from an external device in the certain area where the touch input event is detected.

14. The electronic device of claim 13, wherein the controller is further configured to control to display an entire screen corresponding to the image item, when at least one of a drag input event, a flip input event, a flick input event, or a swipe input event is detected in a state in which the touch input event is maintained in the displayed image item.

15. The electronic device of claim 12, wherein the controller is further configured to control to display any one image item among a pattern image item, a password image item, and a finger scan image item that provide a function of releasing the locked state of screen, an image item that can execute a pre-stored application, and at least any one item that can control an audio function when it is determined that the audio function of the electronic device is activated in the certain area where the touch input event is detected.

16. The electronic device of claim 15, wherein the controller is further configured to:
determine a predetermined pattern form that can release the locked state of screen and
controls to display an image item corresponding to a first pattern among the checked pattern form in the certain area where the touch input event is detected.

17. The electronic device of claim 15, wherein the controller is further configured to:
determine a pre-stored password that can release the locked state of screen, and
control to display an image item corresponding to a first password numeric among the checked password in the certain area where the touch input event is detected.

18. The electronic device of claim 15, wherein the controller is further configured to perform an audio output function or a pause function of audio output based on the touch input event which is maintained in an image item that can control the audio function for a predetermined threshold time.

19. The electronic device of claim 12, wherein the controller is further configured to control to move and display the image item, in a certain area of the screen corresponding to a detected movement input event when the display unit detects the movement input event which is changed according to movement of the touch input event which is maintained in the image item.

20. The electronic device of claim 11, wherein the controller is further configured to determine whether a certain area where the touch input event is detected is included in a predetermined effective touch area.

21. At least one non-transitory computer-readable recording medium predetermined for storing a computer program of instructions configured to be readable by at least one processor for instructing the at least one processor to execute a computer process for performing the method as recited in claim 1.
